(19) United States
(12) Patent Application Publication
(10) Pub. No.: US 2006/0054660 A1
(43) Pub. Date: Mar. 16, 2006

(54) Articulated gas bearing support pads

(75) Inventor: Charles D. Chappell, Treasure Island, FL (US)

Correspondence Address: HONEYWELL INTERNATIONAL INC., 101 COLUMBIA ROAD, P O BOX 2245, MORRISTOWN, NJ, 07962-2245, US

(73) Assignee: HONEYWELL INTERNATIONAL INC., MORRISTOWN, NJ (US)

(21) Appl. No.: 11/004,452

(22) Filed: Dec. 3, 2004

Related U.S. Application Data
(60) Provisional application No. 60/608,819, filed on Sep. 10, 2004.

(51) Int. Cl. A47J 36/02

(52) U.S. Cl. 228/101

(57) ABSTRACT

A gas pad assembly is provided. The gas pad assembly includes a plurality of articulated gas pads. Each gas pad includes a mounting stem having a first and a second end and a gas passage that runs the length of the mounting stem and able to receive gas through the first end, a flexible joint adapted to mate with the second end of the mounting stem with a hole that aligns with the gas passage of the mounting stem, and a support pad that mates with the flexible joint and having a hole that aligns with the hole in the flexible joint. The flexible joint adheres the mounting stem to the support pad and allows the support pad to tilt and move axially with respect to a surface adjacent to a face of the support pad. The plurality of articulated gas pads are positioned about the exterior of a device to float the device in a near frictionless environment when the plurality of gas pads is pressurized with the gas.

### CROSS REFERENCE TO RELATED CASES

This application is related to and claims the benefit of the filing date of U.S. Provisional Application No. 60/608,819 filed on Sep. 10, 2004, entitled GENERALIZED INERTIAL MEASUREMENT ERROR REDUCTION THROUGH MULTIPLE AXIS ROTATION DURING FLIGHT, which is incorporated herein by reference.

This application is also related to the following applications filed on even date herewith, all of which are hereby incorporated herein by reference:

U.S. patent application Honeywell docket number H0006540-1628 (the '6540 Application), entitled “GAS SUPPORTED INERTIAL SENSOR SYSTEM AND METHOD;”

U.S. patent application Honeywell docket number H0006535-1628 (the '6535 Application), entitled “GAS JET CONTROL FOR INERTIAL MEASUREMENT UNIT;”

U.S. patent application Honeywell docket number H0007914-1628 (the '7914 Application), entitled “THREE DIMENSIONAL BALANCE ASSEMBLY;”

U.S. patent application Honeywell docket number H0007169-1628 (the '7169 Application), entitled “SPHERICAL POSITION MONITORING SYSTEM;”

U.S. patent application Honeywell docket number H0007167-1628 (the '7167 Application), entitled “ABSOLUTE POSITION DETERMINATION OF AN OBJECT USING PATTERN RECOGNITION;”

U.S. patent application Honeywell docket number H0007057-1628 (the '7057 Application), entitled “PRECISE, NO-CONTACT, POSITION SENSING USING IMAGING;”

U.S. patent application Honeywell docket number H0006345-1629 (the '6345 Application), entitled “RF WIRELESS COMMUNICATION FOR DEEPLY EMBEDDED AEROSPACE SYSTEMS;”

U.S. patent application Honeywell docket number H0006368-1628 (the '6368 Application), entitled GENERALIZED INERTIAL MEASUREMENT ERROR REDUCTION THROUGH MULTIPLE AXIS ROTATION DURING FLIGHT.”

### TECHNICAL FIELD

The present invention generally relates to a gas bearing support system and in particular to an articulated gas bearing support pad.

### BACKGROUND

Inertial navigation systems (INS) are used in civil and military aviation, missiles and other projectiles, submarines and space technology as well as a number of other vehicles. INSs measure the position and attitude of a vehicle by measuring the accelerations and rotations applied to the system's inertial frame. INSs are widely used because it refers to no real-world item beyond itself. It is therefore resistant to jamming and deception.

An INS may consist of an inertial measurement unit combined with control mechanisms, allowing the path of a vehicle to be controlled according to the position determined by the inertial navigation system. A typical INS uses a combination of accelerometers and any number of control devices.

INSs have typically used either gyrostablized platforms or ‘strapdown’ systems. The gyrostabilized system allows a vehicle's roll, pitch and yaw angles to be measured directly at the bearings of gimbals. One disadvantage of this scheme is that it employs multiple expensive precision mechanical parts. It also has moving parts that can wear out or jam, and is vulnerable to gimbal lock. In addition, for each degree of freedom another gimbal is required thus increasing the size and complexity of the INS.

INSs require periodic rotation to calibrate instruments. There is a need for rotational control of INSs without the use of conventional torque motors eliminating complex parts that add weight, size and cost to the INS assembly. A traditional method of rotating an INS for calibration is to torque it about an axis using electromagnetic motors on a ball bearing supported gimbal axis. A disadvantage of this method is that it employs multiple expensive precision mechanical parts. It also has moving parts that can wear out or jam, and is vulnerable to gimbal lock. Another problem of this system is that for each degree of freedom another gimbal is required thus increasing the size of the inertial system.

Another type of inertial navigation system is one that floats a sensor assembly with neutral buoyancy in a fluid. This method requires an extremely complex assembly, sensitive temperature control and obvious sealing challenges that add considerably to the cost of deployment and maintenance. Also, many of these fluids are hazardous or require a high degree of purity.

Inertial navigation systems which use spherical gas bearings typically require very tight tolerances on the surrounding support shell. These tight tolerances increase the cost of the system and limit the design flexibility of the system.

For the reasons stated above and for other reasons stated below which will become apparent to those skilled in the art upon reading and understanding the present specification, there is a need in the art for a guidance system which is inexpensive and easy to move in all directions without having parts that wear out or require extensive maintenance.

### SUMMARY

The above-mentioned drawbacks associated with existing inertial navigation systems are addressed by embodiments of the present invention and will be understood by reading and studying the following specification.

In one embodiment, an articulated gas pad is provided. The articulated gas pad includes a mounting stem having a first and a second end. The mounting stem is hollow and allows gas to flow between the first and second ends. The gas pad further includes a flexible joint adapted to mate with the second end of the mounting stem and allows gas to flow through an opening in the flexible joint and a support pad that mates with the flexible joint and includes an opening that aligns with the opening of the flexible joint. The support pad is adapted to tilt as well as move axially. The support pad is shaped to conform to an exterior surface of a device to be supported. The support pad self-aligns with the exterior surface of the device when pressurized with gas.

In one embodiment, a gas pad assembly is provided. The gas pad assembly includes a plurality of articulated gas pads. Each gas pad includes a mounting stem having a first and a second end and a gas passage that runs the length of the mounting stem and able to receive gas through the first end, a flexible joint adapted to mate with the second end of the mounting stem with a hole that aligns with the gas passage of the mounting stem, and a support pad that mates with the flexible joint and having a hole that aligns with the hole in the flexible joint. The flexible joint adheres the mounting stem to the support pad and allows the support pad to tilt and move axially with respect to a surface adjacent to a face of the support pad. The plurality of articulated gas pads are aligned about the exterior of a device to float the device in a near frictionless environment when the plurality of gas pads is pressurized with the gas.

In one embodiment, a method of centering an inertial measurement unit in a near frictionless environment within an outer shell is provided. The method comprises arranging equally spaced articulated gas pads around the exterior of the inertial measurement unit in close proximity. The articulated gas pads are thread into threaded bores located in the outer shell so that the articulated gas pads touch the exterior surface of the inertial measurement unit. Gas pressure is applied to the articulated gas pads causing the articulated gas pads to self-align and point substantially towards the center of the inertial measurement unit thus centering the inertial measurement unit within the outer shell. The self-aligning articulated pads reduce the tolerance requirements between the outer shell and inertial measurement mating surfaces.

### DRAWINGS

FIG. 1 is an illustration of one embodiment of an inertial navigation system of the present invention.

FIG. 2A is an illustration of a front view of one embodiment of a mounting stem connected to a support pad to form an articulated gas pad.

FIG. 2B is an illustration of a front view of one embodiment of a mounting stem and a flexible joint of an articulated gas pad.

FIG. 2C is an illustration of a three dimensional view of one embodiment of a mounting stem and a support pad of an articulated gas pad.

FIG. 3A is an illustration of one embodiment of an articulated gas pad.

FIG. 3B is an illustration of another embodiment of an articulated gas pad.

FIG. 4 is an illustration of an articulated gas pad while inserted in an outer shell.

FIG. 5 is an illustration of a gas pad assembly supporting an offset sphere.

FIG. 6 is an illustration of a gas pad assembly supporting a centered sphere.

FIG. 7 is an illustration of a gas pad assembly supporting a sphere.

### DETAILED DESCRIPTION

In the following detailed description, reference is made to the accompanying drawings that form a part hereof, and in which is shown by way of illustration specific illustrative embodiments in which the invention may be practiced. These embodiments are described in sufficient detail to enable those skilled in the art to practice the invention, and it is to be understood that other embodiments may be utilized and that logical, mechanical and electrical changes may be made without departing from the spirit and scope of the present invention. The following detailed description is, therefore, not to be taken in a limiting sense.

Embodiments of the present invention provide a gas support pad assembly design for a spherical gas bearing inertial measurement unit (IMU). This gas support pad assembly allows relaxed tolerance requirements for a surrounding support shell and easy adjustment when an IMU moves due to disturbances. Gas bearings, and more specifically air bearings, are non-contact bearings that utilize a thin film of pressurized air to provide a frictionless interface between two surfaces. The non-contact principles of an air bearing provide clear advantages over traditional bearings since problems such as wear are eliminated. The typical implementation of a spherical air bearing is to have very tight tolerances on two mating surfaces of an inner and outer sphere, with a small air gap between the two. This leads to increased cost and limits design flexibility. The articulated gas pad is an alternative that requires smaller pieces designed with closer tolerances allowing more design and adjustment flexibility in the overall air bearing. The articulated feature allows the support pads to self adjust and automatically find an optimal alignment to the inner spherical surface as well as providing a small gas gap that is proportional to the gas pressure and load. This provides the advantages of lowering the cost of machining due to the parts being smaller and having tighter tolerances held over a smaller area.

Another advantage is the lower cost of machining due to looser tolerances in the alignment requirements. This eliminates the need to lap one part to another and keeps all parts interchangeable. Also, this design requires less assembly time due to the self adjusting nature of the articulated pads. Another advantage is the increase in design flexibility since the size, quantity, and shape of the pads can be altered readily with minimal assembly time and no effect on the supported sphere. Therefore, the present invention eliminates the problems associated with tight tolerances and increases the flexibility of design and reduces the cost of the system.

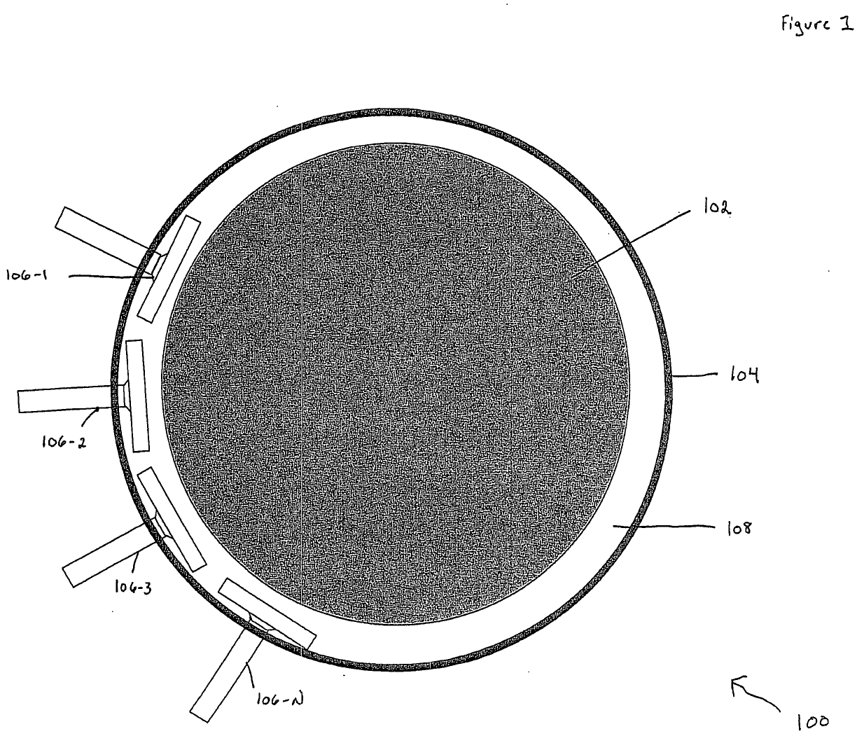

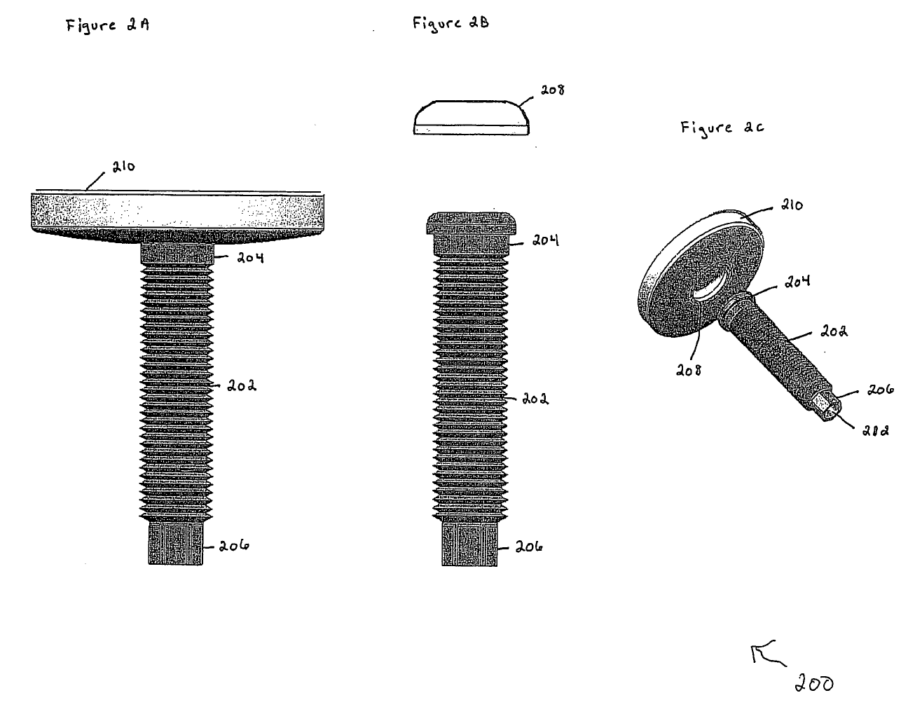

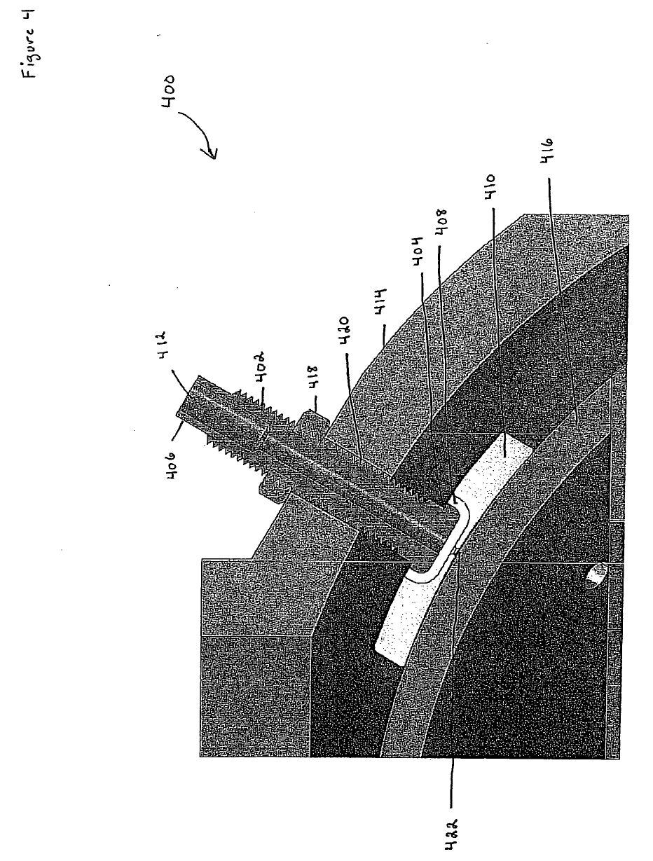

FIG. 1 illustrates one embodiment of an INS of the present invention, shown generally at 100. INS 100 is comprised of a sphere 102. In one embodiment, sphere 102 contains sensors (not shown) as described in FIG. 2 of the '6540 Application incorporated herein. An outer shell 104 surrounds sphere 102 creating a gap 108 between them. In this embodiment, outer shell 104 is substantially spherical in shape. In alternate embodiments, outer shell 104 is a cylinder, a pyramid, a cube or any polygon suited for encapsulating sphere 102 and allowing for suspension and rotation of sphere 102. Gap 108 between sphere 102 and the outer shell 104 is large enough to allow several articulated gas pads 106 to be installed into the outer shell 104 and come within close contact of sphere 102. In one embodiment, articulated gas pads 106 are substantially equally spaced. In one embodiment, articulated gas pads 106 are closer together in a particular direction to handle an increased acceleration loading along that direction. In one embodiment, articulated gas pads 106 are of different sizes to compensate for different loads along the various directions. It is understood, that any combination of sizes and types of articulated gas pads are employed in specific applications. In one embodiment, articulated gas pads 106 are adapted and installed into outer shell 104 as described in FIG. 4 below. Each articulated gas pad 106 has a gas passage (not shown) that runs through articulated gas pad 106 as described in FIG. 4.

In operation, articulated gas pads 106-1 through 106-N are installed into outer shell 104 and are spaced about sphere 102 to provide the required support. Outer shell 104 surrounds sphere 102 creating a gap 108. Articulated gas pads 106 are then aligned to touch the surface of the sphere 102. Pressurized gas is applied to each gas pad 106 and travels through the gas passage (not visible) in each gas pad 106. The pressurized gas causes the gas pads 106 to self-align away from the surface of sphere and create a small gap with even distribution of gas flow around the perimeter of each gas pad 106 causing sphere 102 to be centered in relation to outer shell 104. This causes sphere 102 to be suspended in gas creating a near frictionless environment. In alternate embodiments, this near frictionless environment allows sphere 102 to be rotated in all directions for easy calibration of internal instrumentation.

FIG. 2A illustrates a view of one embodiment of a mounting stem 202 connected to a support pad 210 to form an articulated gas pad shown generally at 200. In one embodiment, mounting stem 202 is threaded and is composed of a first end 204 and a second end 206. First end 204 is inserted into support pad 210 and is held in place using a flexible joint. In one embodiment, flexible joint between first end 204 of mounting stem 202 and support pad 210 is designed using a flexible compound such as an elastomeric compound 208 to fill a gap created between mounting stem 202 and support pad 210. The flexible joint is illustrated below in FIG. 2B. The elastomeric adhesive forms the flexible joint and holds the parts together in a way that allows three degrees of freedom.

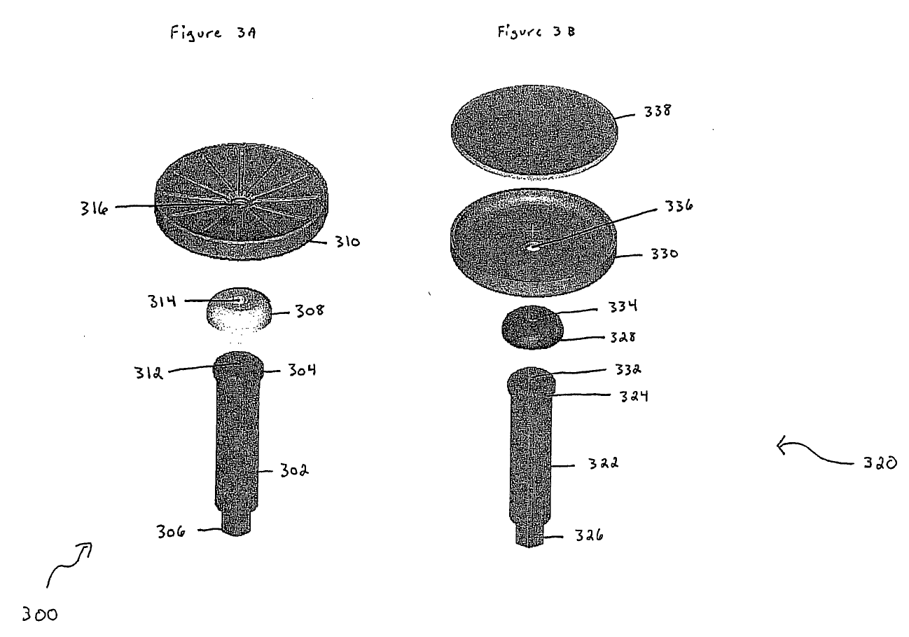

In operation, gas flows through mounting stem 202 and exits through a surface of support pad 210. Second end 206 of mounting stem 202 is adapted to receive a gas hose (not shown) for delivery of gas to support pad 210 for distribution. One embodiment, of an inertial navigation system assembled with one or more gas hoses coupled to first ends of articulated gas pads such as gas pad 200 is described in FIG. 3 of the '6540 Application incorporated herein.

FIG. 2B illustrates a view of one embodiment of mounting stem 202 described above with respect to FIG. 2A separated from a flexible joint 208. First end 204 of mounting stem 202 is adapted to receive flexible joint 208 that fits over the first end 204 as described above.

FIG. 2C is a three dimensional illustration of articulated gas pad 200, as described above with respect to FIG. 2A, with mounting stem 202 and support pad 210 separated. First end 204 of mounting stem 202 fits into flexible joint 208 which is inserted into a support pad 210. In one embodiment, mounting stem 202 and support pad 210 are snap fit together, adhered together, joined together using a mechanical clamp or the like to allow three degrees of freedom.

Flexible joint 208 allows motion in two directions. The flexible joint 208 allows the angle of support pad 210 to change as needed as well as provide axial motion, which allows support pad 210 to self-align from the surface of an adjacent device such as sensor 102 of FIG. 1 above. Support pad 210 self-aligns using gas pressure being applied through an opening 212 along the length of stem 202 to support pad 210 and being resisted by an adjacent surface. Stem 202 is hollow and gas received at one end flows out the other end. In one embodiment, stem 202 and support pad 210 are made of brass or any other suitable material.

FIG. 3A illustrates one embodiment of an articulated gas pad 300. Articulated gas pad 300 is composed of a mounting stem 302 adapted to couple to a flexible joint 308 that is adapted to couple to a support pad 310. In one embodiment, flexible joint 308 is coupled to mounting stem 302 and support pad 310 as described above in FIG. 2A. In an alternate embodiment, mounting stem 302 and support pad 310 are snap fit together, adhered together, joined together using a mechanical clamp or the like to allow three degrees of freedom.

In one embodiment, mounting stem 302 is threaded as described in FIG. 2A. Mounting stem 302 has a first end 304 and a second end 306. First end 304 is adapted to be received by a flexible joint 308 and fits into support pad 310. In one embodiment, flexible joint 308 allows motion in two directions as described above in FIG. 2C. Mounting stem 302 is hollow and opening 312 coincides with hole 314 in flexible joint 308 and hole 316 in support pad 310. Mounting stem 302 is adapted to receive gas through second end 306 via a gas line or a plenum (not shown) as described in FIG. 3 of the '6540 Application. In one embodiment, support pad 310 is concave and shaped to correspond to the exterior surface of an associated IMU.

In operation, articulated gas pad 300 receives gas through second end 306 of mounting stem 302. Mounting stem 302 is hollow and the gas flows out opening 312 and through hole 314 of flexible joint 308. The gas is pushed to the interior of support pad 310 and is distributed through hole 316 and radial lines 385 through the surface of support pad 310 and is resisted by an adjacent surface. It is understood that support pad 310 may include any design for air distribution. In one embodiment, the adjacent surface is an exterior surface of sensor block 102 as described in FIG. 1. Articulated gas pad 300 is initially in close proximity to the adjacent surface and the gas pressure between gas pad 300 and the adjacent surface causes support pad 310 to self-align away from the adjacent surface. The self-alignment is possible due to the flexible joint 308 and how it allows the support pad 310 to move axially (away in this embodiment) and also tilt and compress to conform to the surface shape of the adjacent surface.

FIG. 3B illustrates another embodiment of an articulated gas pad 320. Articulated gas pad 320 is composed of a mounting stem 322 that has a first end 324 and a second end 326. In one embodiment, mounting stem 322 is threaded as described in FIG. 2A. First end 324 is adapted to be received by a flexible joint 328 that fits into a support pad 330. In one embodiment, the flexible joint 328 is as described above in FIG. 3A. Mounting stem 322 is hollow and has an opening 332 that coincides with a hole 334 in flexible joint 328 and a hole 336 in support pad 330. Hole 332 of mounting stem 322 receives gas through second end 326 via a gas hose (not shown) as described in FIG. 3 of the '6540 Application that is received by the second end 326. The support pad 330 has a head 338 which fits into the support pad 330. In one embodiment, gas is dispersed through tiny holes located in head 338. In alternate embodiments, head 338 is made of a porous material.

In operation, gas is received as described above in FIG. 3A. In this embodiment, the gas exits hole 336 of support pad 330 and is widely dispersed through multiple small holes located in head 338. This distribution expands and creates a gas cushion that surrounds the adjacent surface. The pressure between gas pad 320 and the adjacent surface still causes the gas pad 320 to self-align as described above in FIG. 3A.

FIG. 4 illustrates a close up view of an articulated gas pad 400 while inserted in an outer shell 414 of an inertial navigation system. Articulated gas pad 400 is composed of a mounting stem 402 having a first end 404 and a second end 406. In one embodiment, mounting stem 402 is threaded and when assembled is thread into a threaded bore 420 in outer shell 414 and secured by a nut 418. In one embodiment, nut 418 screws onto the mounting stem 402 and abuts outer shell 414 holding gas pad 400 securely in place. Mounting stem 402 fits into a flexible joint 408 which fits into support pad 410 completing the articulated gas pad 400. In one embodiment, flexible joint 408 is an elastomeric compound. The elastomer allows multiple degrees of freedom of movement of support pad 410 relative to mounting stem 402 with a restoring force to return to the original position when there is minimal gas pressure applied as described below. In one embodiment, mounting stem 402 has a gas passage 412 that runs through mounting stem 402 and allows gas to flow through it to inner shell 416. In this embodiment, support pad 410 has a matching hole 422 that corresponds to gas passage 412. Mounting stem 402 is in close proximity to the inner shell 416 and when pressurized gas flows through stem 402 to support pad 410 is resisted by inner shell 416. As a result, support pad 410 is moved away from the surface of inner shell 416 and a gas cushion is created. This movement away from the inner shell 416 is allowed as a result of flexible joint 408 compressing from the gas pressure. Flexible joint 408 also allows support pad 410 to tilt and compress to conform to the surface of inner shell 416 to provide a gap with even distribution of gas flow around the perimeter of each articulated gas pad 400. The even distribution of gas flow around the perimeter of the articulated gas pad 400 is further accomplished by shaping the exterior of support pad 410 to conform to the shape of inner shell 416. In this embodiment, the exterior of support pad 410 is concave and conforms to the convex shape of inner shell 416. Using a plurality of similar articulated gas pads, inner shell 416 is floated in a near frictionless environment. As a result, there is no wear on any parts, gimbal lock is eliminated, and inner shell 416 is freely rotational in three dimensions.

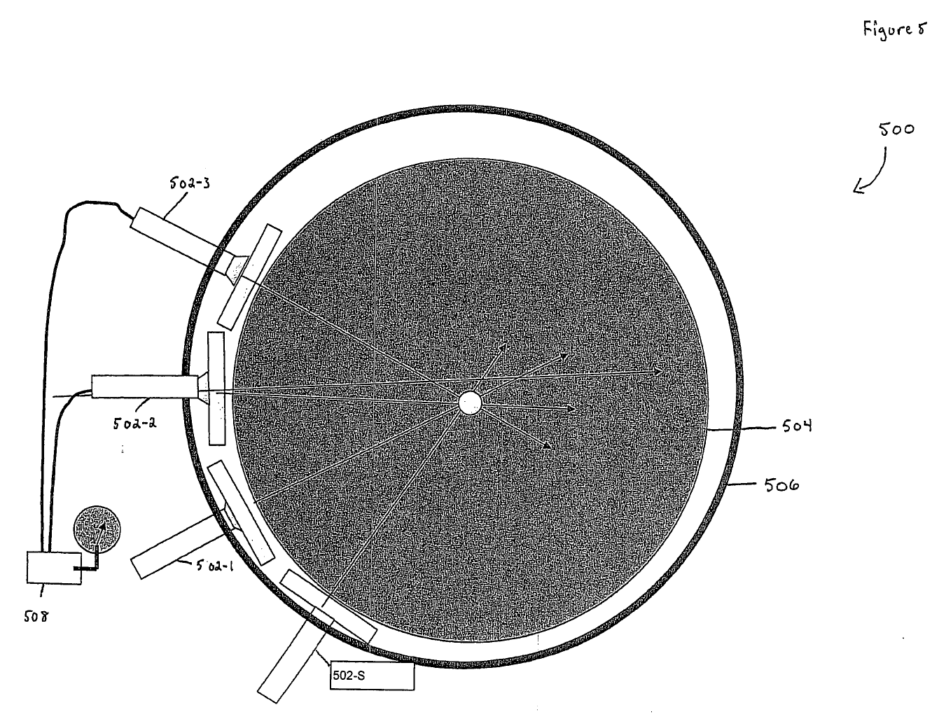

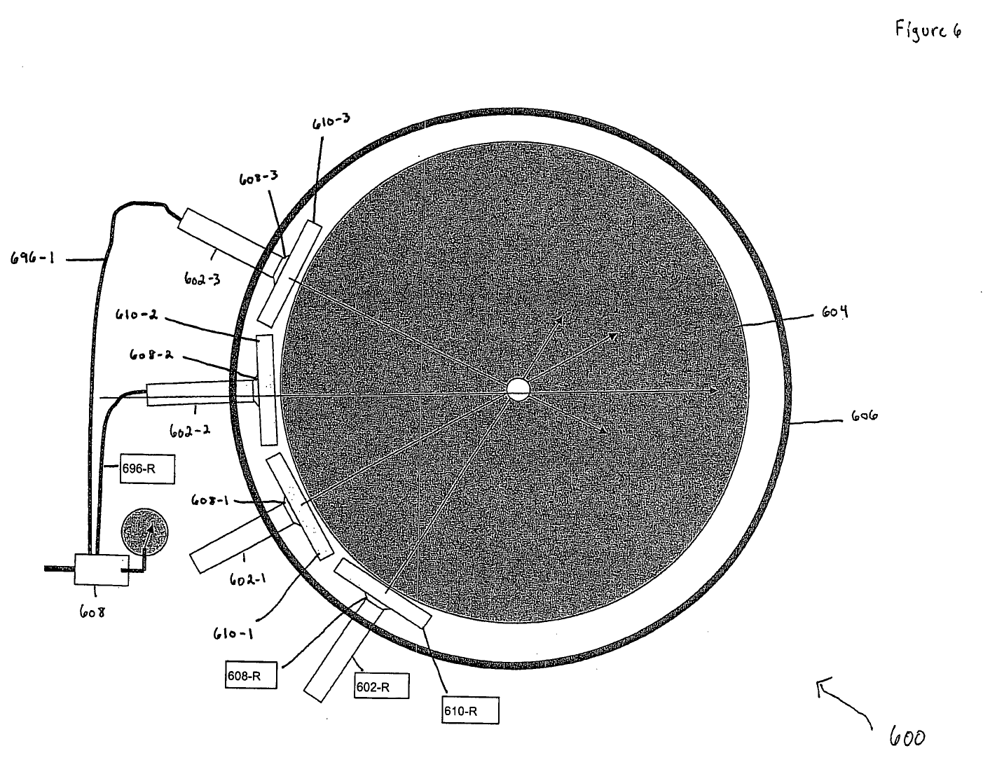

FIG. 5 is an illustration of a gas pad assembly shown generally at 500. Gas pad assembly 500 supports an offset sphere 504. Gas pad assembly 500 has articulated gas pads 502 that surround sphere 504 and float it in gas creating a near frictionless environment inside outer support shell 506. In this embodiment, gas pads 502-1 through 502-S are secured into outer support shell 506. Gas pads 502 are adapted to receive compressed gas from compressor 508. In this embodiment, gas pads 502 are not aligned with the center of sphere 504 causing sphere 504 to be offset and not directly in the center of outer support shell 506. Sphere 504 is offset because the gas pressure has not yet been applied to the articulated gas pads 502. In operation, gas pads 502 are secured into outer support shell 506 as described above in FIG. 4. Gas pads 502 are secured so that they are in close proximity to sphere 504 and sphere 504 is approximately in the center of outer support shell 506. However, manually adjusting gas pads 502 is not an exact science and frequently leads to sphere 504 not being completely centered within outer support shell 506 as shown here. When gas pressure is applied to gas pads 502, the articulated nature of the gas pads 502 causes the gas pads 502 to self align and their direction of force goes through the center of sphere 504 within the outer support shell 506 as shown below with respect to FIG. 6.

FIG. 6 is an illustration of a gas pad assembly 600 supporting a centered sphere 604. Gas pad assembly 600 includes a plurality of articulated gas pads 602 that surround sphere 604 and float it in gas inside the outer support shell 606 creating a near frictionless environment. In one embodiment, assembly 600 includes 32 gas pads 602 that are equally spaced about the exterior of sphere 604. In another embodiment, assembly 600 includes 64 gas pads that are equally spaced about the exterior of sphere 604. In one embodiment, articulated gas pads 602 are closer together in a particular direction to handle an increased acceleration loading along that direction. In one embodiment, articulated gas pads 602 are of different sizes to compensate for different loads along the various directions. In this embodiment gas pads 602-1 through 602-R are secured into the outer support shell 606. Each gas pad 602-1 to 602-R is coupled to a gas compressor 608 via an associated gas hose 696-1 to 696-R. Gas pads 602 receive compressed gas from compressor 608 through gas hoses 696. The gas travels through the articulated gas pads 602 and is dispersed through a support pad of each gas pad 602 at the surface of sphere 604. A cushion of gas is created for sphere 604 to ride upon. Sphere 604 is floated in a near frictionless environment.

In this embodiment, gas pads 602-1 through 602-R are centered about sphere 604 causing sphere 604 to be centered in outer support shell 606. This is accomplished by articulated gas pads 602 ability to move in two directions and tilt, compress, and move axially toward the center of sphere 604 as needed to provide a proper gas gap. Articulated gas pads 602 self-align around the exterior of sphere 604 and the pressure created between articulated gas pads 602 and sphere 604 enable this alignment. The ability of gas pads 602 to tilt and compress is created by the flexible joint 608 in each gas pad 602. The angle of gas pads 602 change as needed to allow gas pads 602 to sit flat against supported sphere 604 while bores (not visible) in outer shell 606 may be at angles that do not go through the geometric center of sphere 604.

When pressurized gas flows through gas pads 602 it is resisted by sphere 604. As a result, support pads 610-1 to 610-R are moved away (fly away) from the surface of sphere 604 and a gas cushion is created. This movement away from sphere 604 is allowed as a result of flexible joints 608-1 to 608-R, located in gas pads 602-1 to 602-R respectively, compressing from the gas pressure. In assembly, gas pads 602 are threaded through shell 606 so that they are in contact with the surface of supported sphere 604. Once the gas supply is turned on, all of the gas pads 602 fly up to a small gap with even distribution of gas flow around the perimeter of each gas pad 602 causing sphere 604 to be centered within outer support shell 606. This self-aligning nature of the articulated gas pads 602 relaxes the tolerance requirements of machining bores in the outer support shell 606 as shown in FIG. 4 to be at angles that go through the geometric center of sphere 604. Also, the self-aligning nature of the articulated gas pads relaxes the tight tolerances usually needed between the surfaces of the sphere 604 and the outer support shell 606.

In operation, gas pads 602-1 to 602-R may be aligned at any distance from sphere 604. In some embodiments, for example in a guidance system, gas pads 602-1 to 602-R are aligned to hold sphere 604 securely. In one embodiment, sphere 604 is an inertial measurement unit of an inertial navigation system and gas pads 602-1 to 602-R holds sphere 604 securely during flight to limit the effects of vibration and the like. In one embodiment, the load L for each gas pad 602-1 to 602-R is calculated according to gas pad 602-1 to 602-R's position. The load on each gas pad 602-1 to 602-R is calculated based on the weight of sphere 604, the number of gas pads 602-1 to 602-R, the gas pressure, the diameter of the support pads for each gas pad 602.

By employing support pads to provide a gas cushion to float an inertial measurement unit upon the need for the inner surface of an outer shell to be perfectly spherical is removed. As a result, the cost to manufacture the outer shell is significantly reduced. In addition, the described inertial navigation system is flexible and can accommodate multiple sizes of spheres. Also, due to the need for the surface of the sphere and its associated outer shell to be perfectly spherical often the sphere has a designated outer shell. With the current inventions, the outer shell is not associated with the inner sphere and can support multiple inner spheres. The current inventions eliminate the complexity and cost of gimbals and bearings.

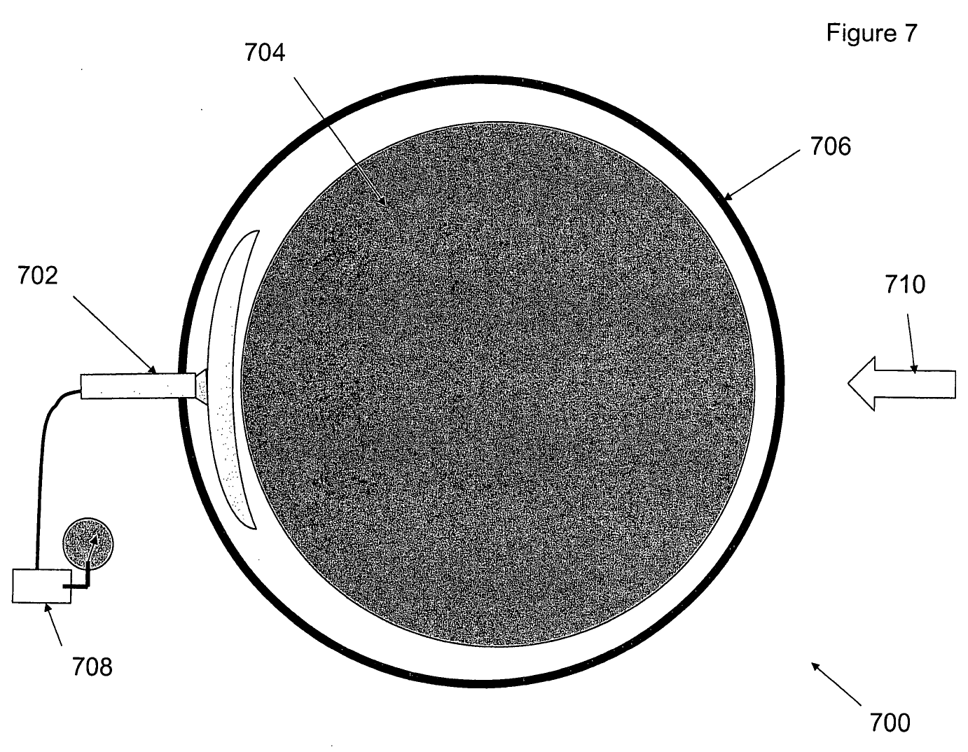

FIG. 7 is an illustration of a gas pad assembly shown generally at 700. Gas pad assembly 700 supports a sphere 704. Gas pad assembly 700 has an articulated gas pad 702 that is cupped to closely match the surface of the sphere 704 and float it in gas creating a near frictionless environment inside outer support shell 706. Articulated gas pad 702 is in line with a resultant acceleration vector 710 which is not changing directions. Articulated gas pad 702 supports the load opposing the acceleration 710 with a small gap resulting in negligible friction. In this embodiment, gas pad 702 is secured into outer support shell 706. Gas pad 702 is adapted to receive compressed gas from compressor 708. In operation, gas pad 702 is secured into outer support shell 706 as described above in FIG. 4. When gas pressure is applied to gas pad 702, the articulated nature of gas pad 702 causes gas pad 702 to self align and the direction of force goes through the center of sphere 704 within the outer support shell 706 as shown above with respect to FIG. 6. As a result, only a single gas pad assembly 700 is needed to support sphere 704 in a near frictionless environment.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

What is claimed is:

1. An articulated gas pad, comprising:
a mounting stem having a first and a second end;
wherein the mounting stem is hollow and allows gas to flow between the first and second ends;
a flexible joint adapted to mate with the second end of the mounting stem and allows gas to flow through an opening in the flexible joint; and
a support pad that mates with the flexible joint and includes an opening that aligns with the opening of the flexible joint;
wherein the support pad is adapted to tilt as well as move axially;
wherein the support pad is shaped to conform to an exterior surface of a device to be supported;
wherein the support pad self-aligns with the exterior surface of the device when pressurized with gas.

2. The pad of claim 1, wherein the mounting stem is externally threaded.

3. The pad of claim 1, wherein the flexible joint is designed using an elastomeric compound.

4. The pad of claim 1, wherein the support pad, mounting stem and flexible joint are mated by snap fitting them together.

5. The pad of claim 1, wherein the support pad is concave to conform to a convex exterior surface of the device to supported.

6. The pad of claim 1, wherein the support pad further comprises a head that fits into the support pad.

7. The pad of claim 6, wherein the head has a plurality of holes that disperse the gas received through the mounting stem

8. The pad of claim 6, wherein the head is made of a porous material.

9. The pad of claim 1, wherein the head has a plurality of radial lines that disperse the gas received through the mounting stem.

10. The pad of claim 1, wherein the first end of the mounting stem is adapted to receive the gas from a gas line.

11. The pad of claim 1, wherein the first end of the mounting stem is adapted to receive the gas from a gas plenum.

12. A gas pad assembly, comprising:
a plurality of articulated gas pads, each gas pad including:
a mounting stem having a first and a second end and a gas passage that runs the length of the mounting stem and able to receive gas through the first end;
a flexible joint adapted to mate with the second end of the mounting stem with a hole that aligns with the gas passage of the mounting stem; and
a support pad that mates with the flexible joint and having a hole that aligns with the hole in the flexible joint;
wherein the flexible joint adheres the mounting stem to the support pad and allows the support pad to tilt move axially with respect to a surface adjacent to a face of the support pad;
wherein the plurality of articulated gas pads is aligned about the exterior of a device to float the device in a near frictionless environment when the plurality of gas pads are pressurized with the gas.

13. The assembly of claim 12, wherein the device is spherical.

14. The assembly of claim 12, wherein the device is a sensor block.

15. The assembly of claim 12, wherein the device is an inertial measurement unit.

16. The assembly of claim 12, wherein the mounting stem is externally threaded.

17. The assembly of claim 12, wherein the flexible joint is designed using an elastomeric compound.

18. The assembly of claim 12, wherein the support pad, mounting stem and flexible joint are mated by snap fitting them together.

19. The assembly of claim 12, wherein the face of the support pad is concave to conform to a convex exterior surface of the device.

20. The assembly of claim 12, wherein the support pad further comprises a head that fits into the support pad.

21. The assembly of claim 20, wherein the head has a plurality of holes that disperse the gas received through the mounting stem.

22. The assembly of claim 20, wherein the head is made of a porous material.

23. The pad of claim 20, wherein the head has a plurality of radial lines that disperse the gas received through the mounting stem.

24. The assembly of claim 12, wherein the first end of the mounting stem is adapted to receive gas from a gas line.

25. The assembly of claim 12, wherein the first end of the mounting stem is adapted to receive gas from a gas plenum.

26. An inertial navigation system, comprising:
a device;
an articulated gas pad assembly that floats the device in a near frictionless environment, including:
a plurality of articulated gas pads spaced about an exterior surface of the device; and
an outer shell that substantially surrounds the device, wherein the outer shell is adapted to receive each of the plurality of articulated gas pads;
wherein each of the plurality of articulated gas pads comprises:
a mounting stem having a first and a second end and a gas passage that runs a length of the mounting stem from the first end to the second end, wherein the first end is adapted to received pressurized gas;
a flexible joint adapted to mate with the second end of the mounting stem with a hole that aligns with the gas passage of the mounting stem; and
a support pad that mates with the flexible joint and having a hole that aligns with the hole in the flexible joint, wherein the flexible joint is formed to allows the support pad to tilt as well as move axially toward the center of the device.

27. The system of claim 26, wherein the device is spherical.

28. The system of claim 26, wherein the device is an inertial measurement unit.

29. The system of claim 26, wherein the mounting stem is externally threaded.

30. The system of claim 29, wherein the outer shell has threaded bores to receive the externally threaded mounting stems of the plurality of articulated gas pads.

31. The system of claim 26, wherein the first end of the mounting stem is adapted to receive pressurized gas.

32. The system of claim 26, wherein the flexible joint is designed using an elastomeric compound.

33. The system of claim 26, wherein the support pad, mounting stem and flexible joint are mated by snap fitting them together.

34. The system of claim 26, wherein the support pad is concave to conform to a convex exterior surface of the device to be floated in a near frictionless environment.

35. The system of claim 26, wherein the support pad further comprises a head that fits into the support pad.

36. The system of claim 35, wherein the head has a plurality of holes that disperse the gas received through the mounting stem.

37. The system of claim 35, wherein the head is made of a porous material.

38. The system of claim 35, wherein the head has a plurality of radial lines that disperse the gas received through the mounting stem.

39. The system of claim 26, wherein an inner surface of the outer shell is substantially spherical.

40. The system of claim 26, wherein the plurality of articulated pads are substantially equally spaced about the exterior surface of the device.

41. The system of claim 26, wherein the plurality of articulated pads are closer together in a particular direction when spaced about the exterior surface of the device.

42. The system of claim 26, wherein the plurality of articulated pads are varied in size.

43. An articulated gas pad, comprising:
a mounting stem having a first and a second end;
wherein the mounting stem is hollow and allows gas to flow between the first and second ends;
a support pad;
wherein the support pad is shaped to conform to an exterior surface of a device to be floated in a near frictionless environment;
wherein the support pad self-aligns with the exterior surface of the device when pressurized with gas; and
a flexible joint that mates the mounting stem and the support pad together and allows movement of the support pad in two dimensions.

44. The pad of claim 43, wherein the mounting stem is externally threaded.

45. The pad of claim 43, wherein the flexible joint is designed using an elastomeric compound.

46. The pad of claim 43, wherein the support pad, mounting stem and flexible joint are mated by snap fitting them together.

47. The pad of claim 43, wherein the support pad is concave to conform to a convex exterior surface of the device to be supported.

48. The pad of claim 43, wherein the support pad further comprises a head that fits into the support pad.

49. The pad of claim 48, wherein the head has a plurality of holes that disperse gas that flows through the support pad.

50. The pad of claim 48, wherein the head is made of a porous material

51. The pad of claim 43, wherein the mounting stem is adapted to fit into an outer shell that surrounds the device to be supported.

52. The pad of claim 43, wherein the first end of the mounting stem is adapted to receive gas from a gas line.

53. The pad of claim 43, wherein the first end of the mounting stem is adapted to receive gas from a gas plenum.

54. A method of floating an inertial measurement unit in a near frictionless environment, the method comprising:
arranging a number of articulated gas pads around the exterior of the inertial measurement unit in close proximity; and
applying gas pressure to the articulated gas pads causing the articulated gas pads to fly up off the inertial measurement unit creating a gas gap between the articulated gas pads and the inertial measurement unit in which the inertial measurement unit is floated in.

55. A method of centering an inertial measurement unit in a near frictionless environment within an outer shell, the method comprising:
arranging a plurality of articulated gas pads around the exterior of the inertial measurement unit in close proximity;
threading the articulated gas pads into threaded bores located in the outer shell so that the articulated gas pads touch the exterior surface of the inertial measurement unit; and
applying gas pressure to the articulated gas pads causing the articulated gas pads to self-align and their respective directions of force point substantially towards the center of the inertial measurement unit thus centering the inertial measurement unit within the outer shell;
wherein the self-aligning articulated pads reduce the tolerance requirements between the outer shell and inertial measurement mating surfaces.

56. An inertial navigation system, comprising:
an articulated gas pad assembly that floats a spherical sensor block in a near frictionless environment the assembly including:
a mounting stem having a first and a second end and a gas passage that runs the length of the mounting stem and able to receive gas through the first end;
a flexible joint adapted to mate with the second end of the mounting stem with a hole that aligns with the gas passage of the mounting stem; and
a support pad that mates with the flexible joint and having a hole that aligns with the hole in the flexible joint and is able to tilt as well as move axially toward the center of the spherical sensor block due to the flexible joint.
